(19) United States
(12) Patent Application Publication
(10) Pub. No.: US 2025/0327297 A1
(43) Pub. Date: Oct. 23, 2025

(54) TIMBER CONSTRUCTION ELEMENTS FOR FLOOR CEILINGS

(71) Applicant: TIMBER STRUCTURES 3.0 AG, Thun (CH)

(72) Inventor: Stefan ZÖLLIG, Thun (CH)

(73) Assignee: TIMBER STRUCTURES 3.0 AG, Thun (CH)

(21) Appl. No.: 18/855,952

(22) PCT Filed: Apr. 4, 2023
(86) PCT No.: PCT/IB2023/053407

§ 371 Date: Oct. 10, 2024

(30) Foreign Application Priority Data
Apr. 27, 2022 (CH) 000491/2022

(51) Int. Cl. E04B 5/43

(52) U.S. Cl. CPC E04B 5/43

(57) ABSTRACT

A mushroom head reinforcement made of wood-based material for supporting and/or carrying timber building panels in building structures, having a base body with an upper surface, a lower surface facing away from the upper surface, and an opening extending from the upper surface to the lower surface. The mushroom head reinforcement has at least one cavity extending over at least part of the upper surface, which is equipped to be filled with an adhesive and to comprise an adhesive layer. In addition, a flat floor ceiling system has the mushroom head reinforcement, support pillars and floor ceiling panels, as well as a method for erecting the system.

### TECHNICAL AREA

The invention relates to timber construction elements for supporting floor ceiling structures in timber construction.

### STATE OF THE ART

Wood is an increasingly attractive raw material in the construction industry and is used as an environmentally friendly alternative to conventional building materials, particularly concrete, for its sustainability and durability.

However, the use of timber components, especially in multi-storey buildings, continues to pose a technical challenge for the construction industry due to the material properties of timber.

It is known, for example, to use load-bearing floor ceilings made of wood-based material for multi-storey buildings by gluing several building panels together on site, as described in WO2014173633.

To support these large timber floor ceilings, large construction panels are placed on support pillars. The pillars are arranged in a grid or pillars, whereby the distance between the pillars should not be too narrow so as not to restrict the use of the space unfavorably due to the number and arrangement of the pillars.

In contrast to concrete ceilings, timber floor ceilings that are not sufficiently supported can bend or sink in between the supports. These unevennesses impair the stability of the floor ceiling, especially under load.

In order to keep the number of supports for timber ceilings as low as possible and to ensure the stability of the timber ceiling, transverse and longitudinal timber beams are usually used, the thickness of which is adapted to the load to be carried. With typical pillar spacing of 8 by 8 meters, this would mean a thickness of the longitudinal and/or transverse beams of approx. 1 m in height.

These bar-shaped beams are conventionally uniaxial load-bearing timber components. This means that they have good stability for forces acting in the longitudinal direction of the fibers, but do not provide stable support for forces acting at right angles to the fibers. For this reason, both longitudinal and transverse beams are usually used to support timber floor ceilings, especially biaxial load-bearing timber floor ceilings.

A biaxial load-bearing timber component, such as a timber floor ceiling, is a component made of wood-based material that is load-bearing over its entire surface.

However, biaxial load-bearing timber floor ceilings are also known from the state of the art, for example floor ceilings made of cross-laminated timber or cross-laminated timber, which can be supported at points.

CN107654009 describes a connection structure that attaches wood supports to CLT wood floor ceiling panels for point support. The connection structure consists of steel components, including structural steel connectors and high-strength threaded steel rods. Steel provides sufficient rigidity and load-bearing capacity to attach the timber supports to the timber panels and transfer the applied forces to them.

To date, however, there is no known technical solution that enables stable, load-bearing, point support of timber floor ceilings without the use of mechanical fasteners made of steel or metal and without concrete components in the support system.

Timber construction aims to reduce the use of these materials as far as possible. It is therefore desirable to find a stable, load-bearing ceiling or floor system for buildings that can essentially be formed from wood-based materials and does not require any additional metal or concrete fixing components.

### Representation of the Invention

It is an aim of this invention to find components made of wood-based material that can provide point support for biaxial load-bearing timber floor ceilings without the need for additional metal or concrete fixing components.

It is a further aim of the invention to find a point-supported floor ceiling system made of wood-based material that is suitable for multi-storey buildings.

According to the invention, these objectives are achieved by a mushroom head reinforcement, a flat deck system and a method for manufacturing this system according to the independent claims. Further optional embodiments are given in the dependent claims.

In particular, one or more of these objectives are achieved by a mushroom head reinforcement made of wood-based material, which has a preferably flat supporting base body with an upper surface, a lower surface and an opening extending from the upper surface to the lower surface. The mushroom head reinforcement also has at least one cavity extending over at least part of the upper surface. The at least one cavity is suitable for receiving adhesive and for forming an adhesive layer.

The at least one cavity enables the mushroom head reinforcement to be bonded to the surface of a timber floor ceiling, in particular a biaxial load-bearing timber floor ceiling, via an adhesive layer of a defined minimum thickness. The minimum thickness of the adhesive layer is determined by the depth of the cavity. The bonding over the adhesive layer encompassed by the cavity is a rigid, two-dimensional bonding. Rigid, flat bonding is essential in order to be able to support biaxial load-bearing panels at points.

The term timber floor ceiling, timber ceiling or timber panel used here means a ceiling floor of a multi-storey building or to panel made of wood-based material or solid wood.

The term component or timber component used here means an element suitable for timber construction made of wood, including wood-based material, solid wood or round timber.

The term wood-based material used here means a material that is produced from joined, shredded wood, for example by gluing. Wood-based materials are, for example, cross-laminated timber, cross-laminated plywood or veneer plywood. Cross-laminated timber and cross-laminated plywood are also known as cross-laminated timber “CLT”. Wood-based materials in which the chopped wood structural elements are arranged crosswise are biaxially load-bearing.

The size and shape of the wood particles determine the type of wood-based material and its properties. The wood particles may be bonded together with or without binding agents. The wood particles may also be bonded together mechanically.

The upper surface and the lower surface of the base body are preferably arranged essentially parallel to each other.

In a preferred embodiment, the opening is arranged in the center or in the central area of the upper surface. Preferably, the opening is therefore arranged in the center of the mushroom head reinforcement so that it opens into the center of the upper surface.

The mushroom head reinforcement may comprise one or more cavities. Several cavities are preferably arranged around the opening. If the mushroom head reinforcement has a single cavity, this should be arranged in a frame or ring shape around the opening. An arrangement of the cavity or cavities around the opening of the mushroom head reinforcement helps to ensure that the bonding of the mushroom head reinforcement is uniform. This improves the stability of the support system.

The cavity or each cavity is at least partially bounded by a closed boundary forming a barrier between the cavity and the opening.

In this context, at least partially means that the closed boundary either bounds one side, for example the inner side of an annular or frame-shaped cavity, while another side, for example the outer side of the cavity, is preferably surrounded by a second boundary, or that the closed boundary completely surrounds the cavity. In the latter case, the boundary is arranged around the periphery of a cavity.

The cavity or each cavity is suitable for receiving adhesive and enclosing a layer of adhesive. The cavity or each cavity is dimensioned in such a way that an adhesive layer can completely fill the cavity.

In a preferred embodiment, the cavity or each cavity has a flat bottom. The flat bottom and lateral boundaries surround the cavity. Preferably, the lateral boundaries determine the depth of the cavity. Each cavity preferably has a uniform depth. This means that the depth of each cavity is essentially constant over its bounding bottom surface.

Preferably, the cavity or cavities have a minimum depth of 1 mm, 2 mm, 3 mm, 4 mm or 5 mm. The depth of the cavity or cavities is preferably no more than 20 mm.

The base body of the mushroom head reinforcement is preferably formed from a biaxially supporting timber component. The forces acting on the base body are therefore transferred in two essentially perpendicular directions arranged in one plane.

In order to provide point support for a timber or wood-based floor ceiling, the base body should preferably have a thickness of 60 mm to 500 mm, from 80 mm to 400 mm, or from 80 mm to 350 mm. The thickness of the base body is preferably determined by the distance between the upper and lower surfaces arranged parallel to each other.

The cavity or cavities may be recesses in the upper surface of the base body. In 10 this embodiment example, each recess is bounded laterally by the walls. For example, a recess may be milled into the upper surface of the base body.

However, the cavity or cavities may also be created by an arrangement of spacers, for example sealing elements on the upper surface. In this embodiment, the spacers are arranged in such a way that they form a closed boundary of a cavity, which constitutes a barrier between the cavity and the opening.

Sealing elements may be made of composite material or rubber, for example. The sealing elements may be foam sealing tapes, for example. Sealing elements are equipped to form hermetic barriers to the opening and to the outside world.

Foam seals are suitable when cavities are created by milling. In this design, the depth of the cavity is essentially determined by the side walls of the cut-out.

In one embodiment of this invention, the cavity is limited by sealing elements that serve as spacers. These sealing elements thus determine the depth of the cavity. These sealing elements form the boundaries of the cavity. To be suitable as a spacer, the sealing element must be made of sufficiently pressure-resistant material, for example rubber.

However, sealing elements are not limited to specific materials. Other materials that are suitable for retaining an adhesive, in particular a casting resin, and forming the cavity, depending on the design of the mushroom head reinforcement, may also be used. The choice of suitable materials is based on the design of the mushroom head reinforcement, as explained above.

Spacers may be glued to the upper surface of the base body.

If the cavity surrounds the opening of the base body in the form of a ring or frame, the cavity has an inner boundary that forms a barrier to the opening and an outer boundary along the outer circumference of the cavity.

If several cavities surround the opening, each cavity should have a closed boundary around its periphery.

The mushroom head reinforcements are designed to be placed on support pillars of the flat floor ceiling. The support pillars are preferably arranged in a grid.

The support pillars have a first portion with a first cross-sectional area and a second, tapered portion with a second, smaller cross-sectional area. The tapered portion of a support pillar is designed to fit through the opening of the mushroom head reinforcement. The tapered portion extends through the entire opening of the mushroom head reinforcement.

The mounted mushroom head reinforcement rests on a shoulder of the support pillar. This shoulder is formed by the upper end of the lower portion. The shoulder runs around the tapered portion. The shoulder bears the weight of the mushroom head reinforcement resting thereon.

The upper surface of the mushroom head reinforcement is preferably larger than the cross-section of the first portion of the support pillar. The upper surface preferably protrudes laterally beyond the support pillar. The lower surface of the mushroom head reinforcement is preferably smaller than the upper surface of the mushroom head reinforcement.

The lower surface may be dimensioned in such a way that it coincides with that on the bearing surface of the shoulder of the support pillar, so that the lateral outer surface of the first portion of the support pillar is flush with the lateral side(s) of the mushroom head reinforcement. This design optimizes the force transmission of the mushroom head reinforcement to the first portion of the support pillar.

The shape of the cross-sections through the first portion and/or the second portion of the support pillar, as well as the upper surface and/or lower surfaces of the mushroom head reinforcement, is not specifically limited.

The base body of the mushroom head reinforcement may have a square cross-section, for example. However, the base body may also have a round or polygonal cross-section. As the mushroom head reinforcement is intended for point support of panels, elongated designs are less suitable. In contrast to support pillars, the mushroom head reinforcement is not a bar-shaped support element.

For example, the reinforcement may have a square or round cross-section in its two portions. The geometric shape of the cross-sections of the two portions may be different or the same. The shape of the cross-section of the second portion is limited by the shape of the opening of the mushroom head reinforcement, as the second portion should be designed to fit into the opening.

In one embodiment, the support pillar is made of a wood-based material.

However, the support pillar may also be made of other suitable building materials, such as concrete, fiber-reinforced concrete, reinforced concrete, steel or a combination of building materials. It is also possible to use timber supports and reinforce them with additional steel elements. For example, a steel plate may be inserted between the upper and lower timber support pillar, or other steel parts may be integrated into or surround the tapered part of the support pillar. These steel elements serve exclusively to reinforce the support pillar but are not attached to the mushroom head device. These elements are not used to fix the mushroom head reinforcement to the floor ceiling and/or the pillar.

The timber flat floor ceiling is placed on the mushroom head reinforcements attached to the support pillar. The timber flat floor ceiling preferably consists of biaxial load-bearing panels made of a wood-based material. The panels are preferably cross-bonded panels or plywood panels.

In a multi-storey building, the pillars of a storey are erected along the geometric central axis of the pillars of the storey below. The pillar of the upper storey forms the continuation, so to speak, of a pillar of the storey below. This arrangement of the support pillar means that the load force introduced into the upper support pillars is transferred to the support pillars below. This arrangement prevents the floor ceiling from being overloaded at certain points by the pillars erected on the panels and from deforming or failing under lateral pressure.

In one embodiment, the panels have a greater thickness in the portions that rest on the mushroom head reinforcements compared to the rest of the panel. The thickness of a panel is preferably increased by 10% to 150% in these portions. In this embodiment, the greater thickness of the panel acts as a mushroom head reinforcement.

In another embodiment, the portions of the panels that rest on the mushroom head reinforcements are reinforced with additional flat components, such as boards. In this embodiment, the mushroom head reinforcements are attached to the panel.

The two designs mentioned in the previous paragraphs offer the advantage that the area of the panel that is exposed to the greatest force is additionally reinforced, which improves the load-bearing capacity of the floor ceiling.

However, it is also possible for the mushroom head reinforcements to be attached flush to areas of the panel that have no additional structural reinforcements. In this model, the mushroom head reinforcements are integrated into the panel.

In one embodiment, the panels have transverse through-openings through which the tapered portions of the support pillars are guided. For this embodiment, support pillars are used whose tapered portions extend through the entire lengths of the opening of the mushroom head reinforcement and the through opening of the panel.

In this design, the pillars of an upper storey are in direct contact with the pillars of the storey below. More precisely, the lower surfaces of the first portion of the upper pillar interact with the upper surfaces of the second portion of the pillar below. Because the first portion of the pillars has a larger cross-section than the second portion, part of the lower surface of the upper pillar rests on the tapered portion of the pillar below. The weight of the upper support pillar and the force applied to the upper support pillar are thus transferred to the tapered portion of the support pillar below without transferring the force via the floor ceiling.

In one embodiment, the upper and lower end areas of the support pillars are tapered so that these areas partially protrude into a passage opening of a floor ceiling and interact there with the tapered ends of the support pillar above or below, respectively, which are inserted into the passage opening. In this design, it is particularly advantageous for timber support pillars to insert a metal plate, preferably a steel plate, between the end faces of the support pillars. The metal plate improves the transfer of compressive force from the upper to the lower support pillar.

In another embodiment, only one end portion of a support pillar may be tapered to extend through the length of the passage opening and to interact with the support pillar below or with the support pillar above. As in the previous example, a metal plate may also be installed between the contact surfaces of the two support pillars in order to optimize the transmission of compressive force.

In another version, the support pillars may sit on top of the openings without protruding into them. In this case, the contact surfaces of the support pillars with the floor ceiling are larger than the passage opening. In this case, a metal element, preferably a steel element, is preferably provided to transfer the compressive force from the upper to the lower support pillar. The metal element preferably has two metal plates, with one metal plate contacting the lower end surfaces of the upper support pillar and the other metal plate contacting the upper end surface of the lower support pillar. The metal element also has a central connecting portion, preferably a cylindrical portion. The connecting portion extends through the through opening.

The weight of the floor ceiling, as well as the load force acting on and transferred to the floor ceiling, is transferred to the first, lower portion of the pillar via the mushroom head reinforcement.

The cavities of the mushroom head reinforcement are intended to be filled with adhesive in order to bond the mushroom head reinforcements to the surface of the floor ceiling or the panels of the floor ceiling. For this purpose, the adhesive is cast or injected into the cavities of the mushroom head reinforcements when the panels rest on the mushroom head reinforcements.

The cavities are completely filled with adhesive. The cured adhesive forms an adhesive layer. The thickness of the adhesive layer corresponds to the depth of the respective cavity.

The cavity of the mushroom head reinforcement ensures that the area of the upper surface of the base body to be bonded does not make contact with the panel. There is therefore a distance between this area of the upper surface and the panel, which is defined by the closed boundary.

Wood-based materials are natural building materials that adapt to the prevailing indoor climate. Wood can swell, shrink or warp. Furthermore, the surface of a timber component is normally not completely even but comprises an unevenness. In order to bond two flat timber components together firmly and stably, fixing elements are therefore usually required to generate sufficient pressure on the surfaces to be bonded in order to ensure the accuracy of fit of the adhesive joint.

In the present invention, the joint formed by the cavity is already fixed before bonding or casting. In contrast to press bonding of flat sides of components, the volume or the dimensions of the joint corresponding to the cavity are constant during bonding.

It is possible to fill the cavity of the mushroom head reinforcement with adhesive before the panels of the floor ceiling are laid on the mushroom head reinforcement. However, air pockets can easily form between the adhesive and the panel when the panels are laid. Complete filling of the cavity with adhesive is therefore not guaranteed.

By filling or injecting the adhesive after the panels have been placed on the mushroom head reinforcement, it can be ensured that the existing cavities are completely filled. The poured adhesive is distributed throughout the entire cavity and penetrates into small cracks and unevenness in the boundary surfaces so that all unevenness is filled with adhesive. The air trapped in the cavity is displaced by the adhesive through vent openings as described below.

The cavities of the mushroom head reinforcements allow the use of a casting resin, preferably a two-component casting resin. The adhesive layer in the cavities can adapt to the natural texture of the bonded surfaces of the timber components and fill in their unevenness, so that a rigid, two-dimensional bond can be created between the components. This rigid, two-dimensional bonding results in a robust connection between the components so that no additional fixing elements are required to stabilize the connection.

The adhesive layer takes over the full force transmission. The weight of the panel and the forces acting on the panel are fully transferred to the adhesive layer, which then transfers them to the mushroom head reinforcement.

Fill openings and vent openings are provided in the panels of the floor ceiling to fill the cavities of the pillar body. These openings may be holes, for example. The openings extend transversely across the thickness of the panels.

The fill openings and the vent openings are designed in such a way that at least one fill opening and one vent opening open into a cavity. If a cavity is segmented, at least one fill opening and one vent opening open into a segment.

In one embodiment, one fill opening and several vent openings open into a segment of a cavity or into a cavity.

The complete distribution of an adhesive in a horizontal joint presents a considerable difficulty. Vertical joints are conventionally filled from below to prevent air bubbles from being trapped. For horizontal joints, this is only possible with difficulty and is also less effective.

The cavities between the mushroom head reinforcement and the floor ceiling are horizontal joints. The even distribution of the adhesive over the entire cavity and the complete filling of the cavity is important for the load capacity and stability of the joint. Uneven distribution of the adhesive may lead to the inclusion of air bubbles, which weaken the joint.

In order to improve the filling and distribution of the adhesive and to be able to control it better, it is advantageous to divide cavities into separate segments. The filled adhesive is distributed more evenly over the entire cavity if it is filled into the individual segments of the subdivided cavity. Furthermore, the filled adhesive can be distributed more quickly in the smaller volume of the segment than over a uniform total volume of the cavity.

In a preferred embodiment, the adhesive is a casting resin. Preferably, the adhesive is a two-component casting resin. This casting resin may be a polyurethane casting resin, for example.

Preferably, the adhesive is a paste-like adhesive, in particular a paste-like casting resin. The term paste-like here means that the adhesive has a dynamic viscosity of 25,000 mPa's up to 100,000 mPa·s.

A paste-like adhesive is particularly suitable for casting the cavity, which is a horizontal joint, because air pockets can be avoided due to the viscous properties of the adhesive. Casting as used here implies filling completely.

In order to reduce noise transmission through the floor ceiling system described here, the panels of the floor ceiling as well as the mushroom head reinforcements and the support pillars may be fitted with sound insulation elements.

The attachment of sound insulation elements, for example sound insulation membranes, to panels made of wood-based materials is generally known and is not explained in detail here.

Even if the panels of the floor ceiling are soundproofed, sound can still be transmitted via the mushroom head reinforcements and the support pillars.

To prevent this, mushroom head reinforcements and support pillars may preferably also be fitted with sound insulation elements, preferably using a sound insulation system.

The soundproofing elements of the soundproofing system may comprise generally known soundproofing materials, such as an elastomer, for example PUR elastomer. The soundproofing elements can, for example, be one or more soundproofing membranes.

In one embodiment, the sound insulation system includes a first component that rests on the shoulder of the support pillar. The sound insulation system preferably also has a second component that forms a layer around the tapered portion of the support pillar.

The first component of the preferably covers the shoulder completely. The first component may be glued to the shoulder.

The second component preferably completely surrounds the side surface(s) of the tapered portion of the support pillar. The second component may be tubular and pulled over the tapered portion. However, the second component may also be planar and be wound around the second portion in one layer. The second component may be glued to the tapered portion.

The first and second components may be separate components. However, the first and second components may also be connected to each other in such a way that they form a single piece.

To ensure optimum sound insulation, the first and second components should be contiguous and completely cover the shoulder and the lateral sides of the tapered portion of the support pillar. The two components should preferably form a hermetic covering of the shoulder and the lateral surfaces of the tapered portion.

The two components may be flush with each other. However, the two components may also overlap each other. The two components may be glued together.

The shape of the first component and the second component should be selected so that they can be easily and appropriately arranged on the surfaces of the shoulder or the tapered portion to be covered.

In one embodiment, the shoulder and/or side surface(s) of the tapered portion are each covered by a plurality of first and second components, respectively. For example, several strips or differently shaped parts of soundproofing materials may be arranged on the shoulder and/or on the side surface(s) of the tapered portion of the support pillar. This plurality of parts should be arranged over as large an area as possible in order to achieve good sound insulation.

The invention also relates to a method for producing a point-supported floor ceiling system.

### BRIEF DESCRIPTION OF THE FIGURES

The invention is explained in more detail with reference to the attached figures, which show

FIG. 1A schematic three-dimensional view from above of an example of a mushroom head reinforcement in which the cavity is formed as a flat recess in the upper surface;

FIG. 1B is a schematic top view of the embodiment shown in FIG. 1;

FIG. 2A is a schematic top view of the upper surface and two lateral surfaces of the embodiment shown in FIG. 1, which is made of cross-laminated plywood;

FIG. 2B a schematic top view of the upper surface and two lateral surfaces of the embodiment shown in FIG. 1, which is made of veneer plywood;

FIG. 3A a schematic top view of an example of a mushroom head reinforcement, the cavity of which is divided into rectangular segments;

FIG. 3B a schematic top view of an example of a mushroom head reinforcement, the cavity of which is divided into square segments;

FIG. 3C a schematic top view of an example of a mushroom head reinforcement, the cavity of which is divided into larger rectangular segments filled with adhesive;

FIG. 3D is a schematic top view of an embodiment example with four disk-shaped cavities arranged around the central opening;

FIG. 4 is a schematic representation of an example of a cavity which is filled through a central fill opening and has four vent openings arranged in the corners of the square cavity;

FIG. 5A a schematic side view of an embodiment of a support pillar;

FIGS. 5B, 5C and 5D schematic top views of various possible versions of a support pillar;

FIG. 6A is a schematic, lateral cross-sectional view of a portion of an embodiment of a floor ceiling;

FIG. 6B a schematic three-dimensional view from above of a portion of an embodiment of a floor ceiling, in which the structures not visible from above are indicated as interrupted elements;

FIG. 6C is a schematic representation of the arrangement of the panels, mushroom head reinforcements and support pillars of the portion of the floor ceiling shown in FIG. 6B;

FIG. 7A a schematic three-dimensional view from above of an arrangement of an embodiment of a three-level floor ceiling system according to the present invention;

FIG. 7B a schematic three-dimensional view from below of an arrangement of an embodiment of a three-level floor ceiling system according to the present invention.

### DETAILED DESCRIPTION

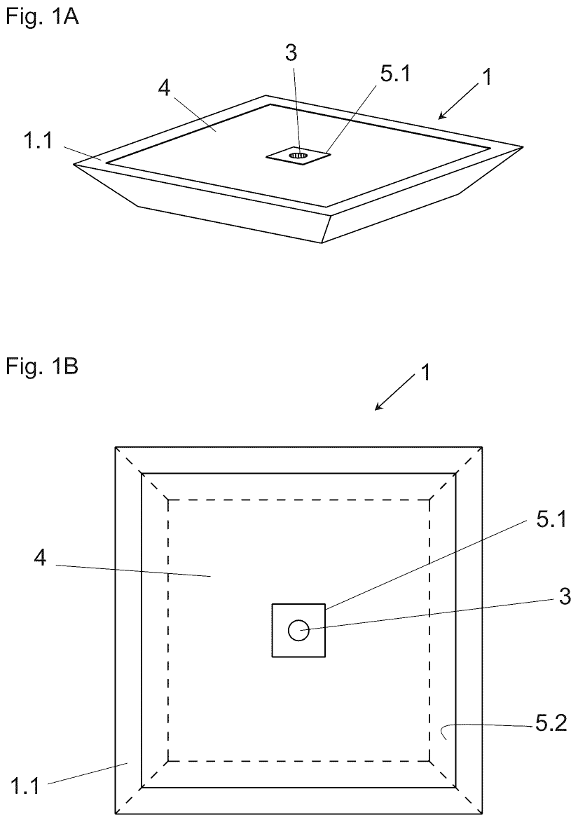

The embodiments of a mushroom head reinforcement 1 according to the present invention are illustrated in FIGS. 1A to 3D.

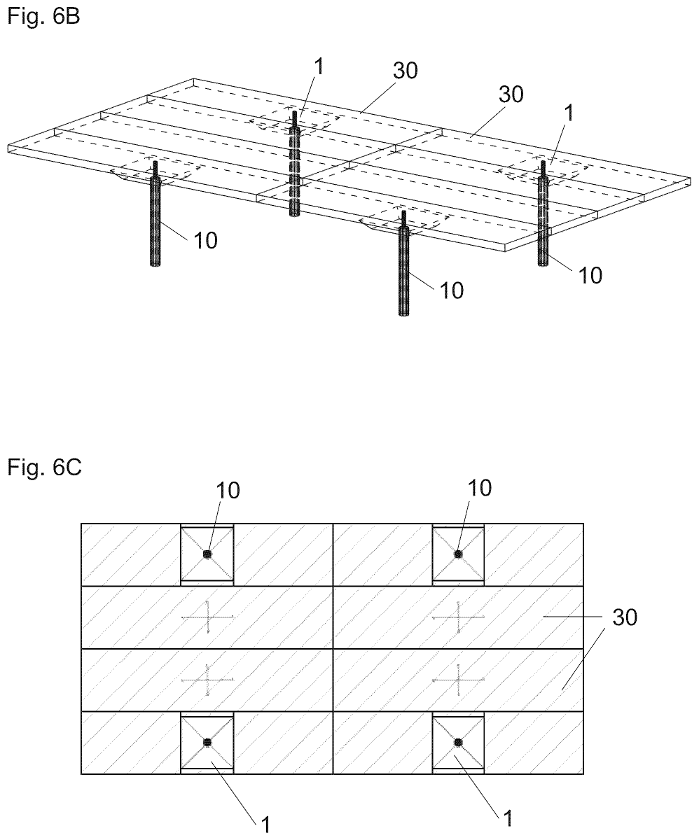

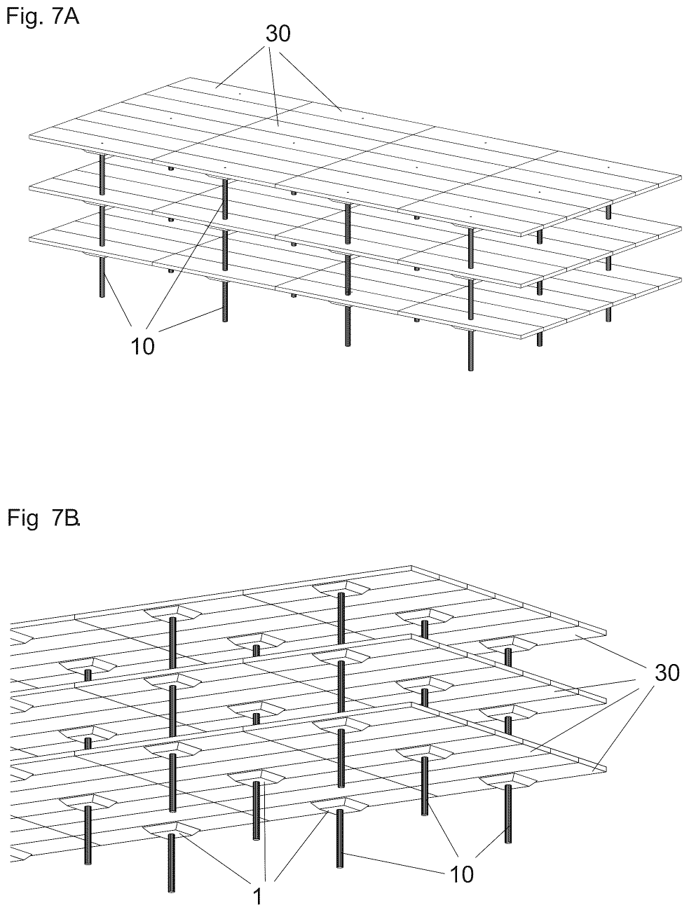

The examples given here represent designs with a base body that has a square upper surface 1.1 that tapers towards an equally square lower surface 1.2 (FIGS. 6A and 7B). The base body shown has the shape of a flattened, inverted truncated pyramid with a square base.

The lateral walls of the mushroom head reinforcement may rise from the lower surface 1.2 to the upper surface 1.1 at a slope angle of preferably 30° to 90°, from 45° to 90°, or from 60° to 90°.

However, the invention is not limited to this specific shape. For example, the base body may also have the shape of a flattened truncated cone with a lower surface 1.2 that has a smaller diameter than the upper surface 1.1.

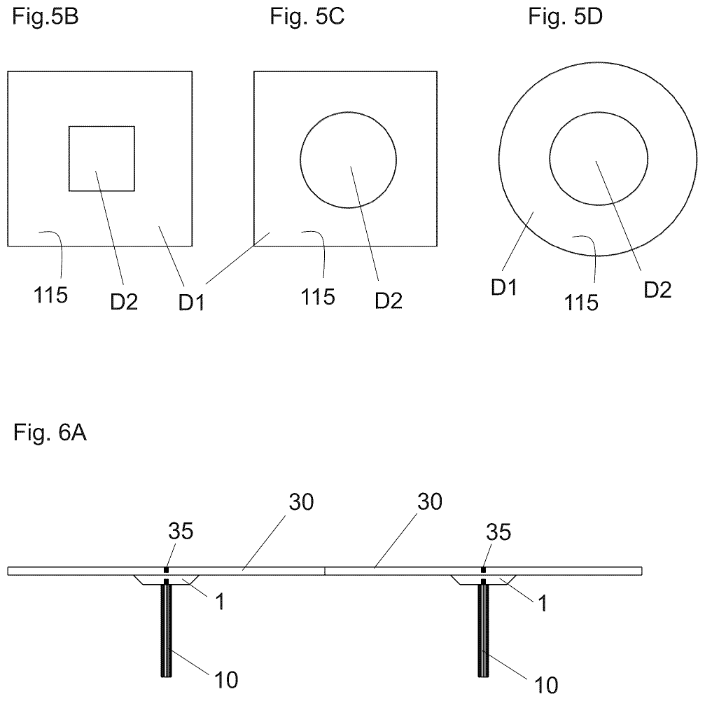

Preferably, the lower surface 1.2 is smaller than the upper surface 1.1. The lower surface 1.2 acts together with the surface formed by a shoulder 115 of a support pillar 10 (FIGS. 5A to 5D).

The base body of the mushroom head reinforcement 1 has a continuous transverse opening 3 between the upper surface 1.1 and the lower surface 1.2. This opening is preferably arranged in the center, or in a central area, of the upper surface 1.1 and/or the lower surface 1.2.

The mushroom head reinforcement also has one or more cavities, which are either arranged on the upper surface 1.1 or represent the recesses of the upper surface 1.1. Recesses may be incorporated into a base body. Recesses may be milled in, for example.

The cavity or cavities are designed in such a way that they may be cast with an adhesive, preferably a paste-like casting resin, for example a two-component casting resin. The shape of the cavity is such that the adhesive can harden in a cavity to form an adhesive layer with a defined thickness.

The thickness of the cured adhesive layer is determined by the boundaries 5.1, 5.2 of a cavity 4. Preferably, the thickness of the cured adhesive layer is at least 1 mm, 2 mm, 3 mm, 4 mm or 5 mm. Preferably, the thickness of the adhesive layer should not exceed 20 mm.

Preferably, the thickness of this cured adhesive layer is substantially homogeneous, except for minor variations due to the natural nature of the wood-based material. These minor deviations are generally no more than 5%, no more than 10%, or no more than 25% of the thickness of the adhesive layer.

FIGS. 1A to 3B show embodiments which each have a single cavity 4 surrounding the central opening, which is formed by a recess in the upper surface 1.1. In these examples, the cavity 4 is in the form of a closed recess surrounding a central area of the upper surface 1.1. The lateral walls of the recess form an inner boundary 5.1 to the opening, as well as an outer boundary 5.2.

However, it is also possible that the cavity is not a recess but is formed by protrusions of the mushroom head reinforcement.

In another embodiment, the cavity is delimited by spacers arranged on the upper surface 1.1 of the mushroom head reinforcement, which are, for example, sealing elements. The cavity thus rests on the upper surface 1.1.

In order to be able to support biaxial timber panels in a planar and point-like manner, the mushroom head reinforcement should be designed to be biaxially load-bearing. For this reason, the mushroom head reinforcement is preferably made of a biaxially load-bearing wood-based material.

For the planar support of timber floor ceiling panels in buildings, mushroom head reinforcements of the present invention preferably have a thickness of 60 mm to 500 mm, of 10 mm to 400 mm, or of 150 mm to 350 mm.

The upper surface of a mushroom head reinforcement made of cross laminated timber is preferably between 0.5 m² and 9 m². The upper surface of a mushroom head reinforcement made of veneer plywood is preferably between 0.5 m² and 9 m².

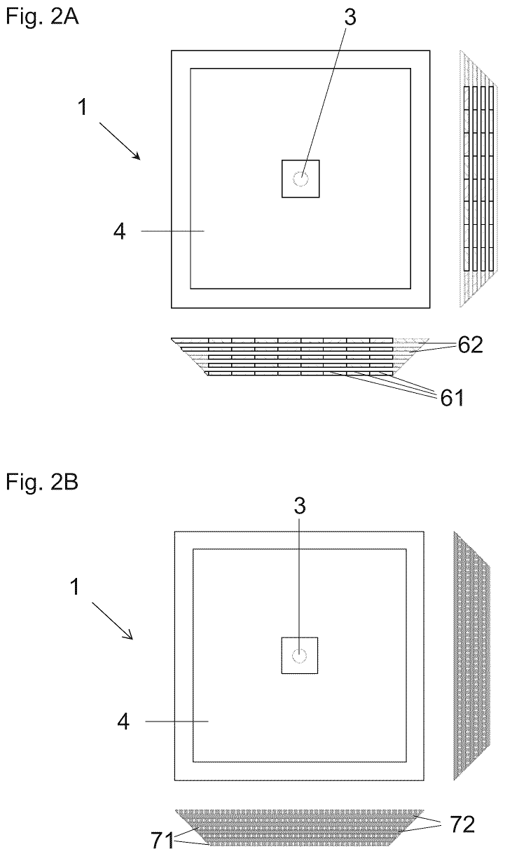

FIG. 2A shows a base body made of cross laminated plywood. Two lateral outer walls of the base body are shown in a plan view next to the upper surface. The obliquely hatched layers correspond to end-face cross-sectional areas of timber lamellae 61 arranged parallel to each other. The layers without hatching represent portions parallel to the main grain direction 62 of the timber lamellae. The long sides of the timbers can be seen in these layers.

FIG. 2B shows a base body made of veneer plywood. Two lateral outer walls of the base body are shown in a plan view next to the upper surface. The horizontally shaded layers correspond to end-face cross-sectional areas 71, the dark intermediate layers 72 are portions along the main grain direction.

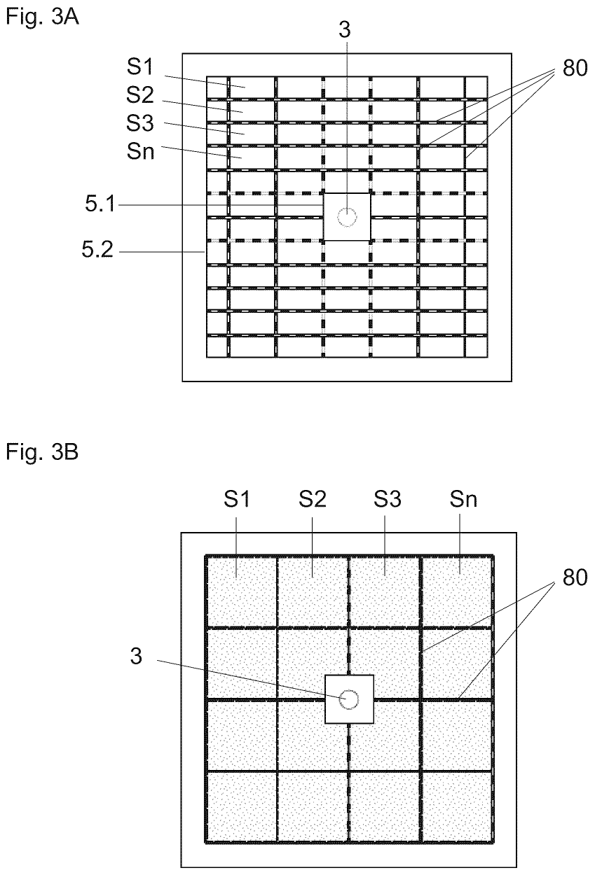

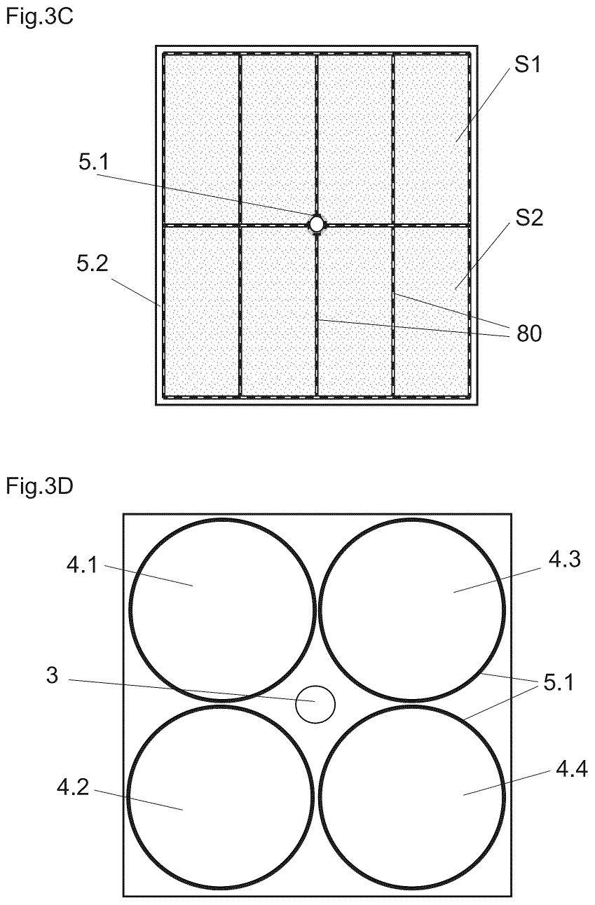

In FIGS. 3A and 3B, the cavity 4 of an embodiment example with a single cavity is divided into several segments S1, S2, S3, Sn. The segments are separated from each other by barriers 80, which may be seals or partitions. The segments are individually sealed with adhesive. In FIG. 3B, segments filled with adhesive are shown as dotted areas.

In the embodiment example shown in FIG. 3C, a mushroom head reinforcement is provided with a single cavity defined by an inner boundary 5.1 and an outer boundary 5.2, both of which are arranged on the upper surface of the base body. The boundaries may be created, for example, by spacers, which are preferably sealing elements. The cavity in FIG. 3C is segmented.

In one embodiment, several cavities are preferably arranged regularly around the central opening. This is shown, for example, in FIG. 3D.

FIG. 3D shows a mushroom head reinforcement with several cavities 4.1, 4.2, 4.3, 4.4, in this specific case with four cavities. The cavities are each defined by closed boundaries 5.1, which are arranged on the upper surface of the base body. These closed boundaries represent barriers to the opening and to the other cavities.

The segments may take on various geometric shapes. Segments may be square, rectangular or triangular, for example. Square-shaped segments have the advantage that they can be cast better, in particular more regularly, through a central fill opening, as explained below.

Several cavities arranged around the opening may also have different shapes. Disc-shaped or square shapes are preferred, as these shapes are easier to cast through a central fill opening.

The at least one cavity, or the separate segments of the mushroom head reinforcement, are cast after the mushroom head reinforcement has been placed on the support pillar and the floor ceiling panel of the mushroom head reinforcement has been placed on top. The cavity is therefore covered by the panel of the floor ceiling. Fill openings 31 and vent openings 32 are provided in the panels for filling the at least one cavity or the segments. At least one fill opening and at least one vent opening must open into each segment or, if the cavity is not subdivided, into each cavity.

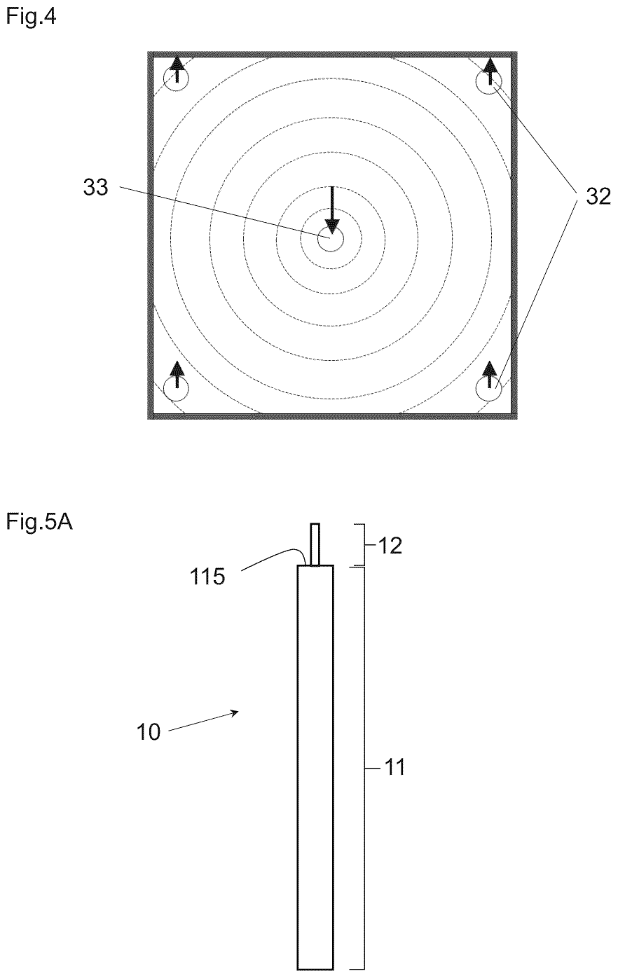

FIG. 4 schematically shows a preferred arrangement of a fill opening 31 and vent openings 32 in a square cavity or a square segment. In this figure, only the fill opening 31 of the panel and the vent openings 32 can be seen, the panel itself is transparent to allow a view into the cavity. The black arrows indicate the flow direction of the adhesive or the air displaced from the cavity.

The adhesive is filled into the cavity or segment through a single fill opening 31 in the panel. The fill opening 31 of the panel is arranged in such a way that it opens into the center of the cavity or segment.

The filled adhesive spreads concentrically in all directions from the central fill opening. This is indicated in FIG. 4 by the concentric interrupted lines. The air is displaced outwards by the adhesive, with the greatest risk of air bubbles forming in the corners of the cavity.

In order to avoid the formation of air bubbles in the corners, the vent openings 32 of the panel are therefore preferably arranged so that they open into the corner areas of the cavity.

The cavity in FIG. 4 is square and has four vent openings 32 in its corner areas. However, a cavity or segment may also have a polygonal geometric shape, for example a pentagon or a hexagon. In these polygonal shapes, it is also advantageous to arrange the vent openings in at least some of the corner areas.

The cavity or segment may also be designed without corners, for example disc-shaped or elliptical. In this case, the vent openings 32 should be arranged along the periphery of the cavity.

It is also possible to provide cavities or segments with a triangular basic shape. However, this shape is less favorable, as air bubbles can get trapped more easily in acute-angled corners than in corners with an angle of at least 90°.

The viscosity of the adhesive also influences the risk of air bubbles forming. Adhesives that flow well tend to spread quickly across the base of the cavity or segment and trap air bubbles along the joining surface of the panel resting on the mushroom head reinforcement when filling. For this reason, an adhesive with increased viscosity, which is suitable for filling through the fill opening on the one hand and which spreads viscously through the cavity on the other, is more suitable.

To reduce the risk of air entrapment, the adhesive should have a dynamic viscosity of 10,000 mPa's to 100,000 mPa's, better from 25′000 mPa's up to 100′000 mPa·s.

In a preferred embodiment, the adhesive is a two-component adhesive.

Preferably, the adhesive is a casting resin, for example a two-component polyurethane, or an epoxy resin.

The point-supported girder system for the biaxial flat floor ceilings comprises the mushroom head reinforcement which is attached to a pillar with shoulder 115 as described above.

Possible embodiments of the support pillar according to the present invention are shown in FIGS. 5A to 5D. The support pillar 10 has a lower, first portion 11 of a cross-sectional area D1, and an upper, second portion 12 of a cross-sectional area D2, wherein D1 is larger than D2. The upper portion is a tapered portion. The shoulder 115 formed by the lower portion 11 surrounds the upper, tapered portion 12. FIG. 5A is a schematic side view of a support pillar 10.

Various shapes of the cross-section of the two portions of the support pillar are possible. The shape of the support pillar is not particularly limited. However, the shape of the tapered portion 12 must be compatible with the shape of the opening 3 of the mushroom head reinforcement and, if applicable, the floor ceiling panels.

Several possible embodiments of the support pillars 10 are shown schematically in FIGS. 5B, C and D.

FIGS. 6A, B and C are different views of a possible embodiment of a mushroom floor ceiling system according to the present invention. The system comprises biaxial load-bearing timber panels 30, which are placed on the mushroom head reinforcements 1 attached to the support pillars 10. The floor ceiling panels have fill openings and vent openings (not shown).

In the embodiment example shown, the panels 30 have a through-opening 35 through which the tapered portions of the support pillars 10 extend.

However, it is also possible to use panels without through-openings. In this case, the underside of the panel preferably rests on the mushroom head reinforcement and the tapered portion that extends through the mushroom head reinforcement.

FIG. 6A is a schematic, lateral cross-sectional view through the center of the mushroom head reinforcement or support pillar.

FIG. 6B, which shows a schematic three-dimensional view from above of the same embodiment, shows eight floor ceiling panels 30, which are point-supported by four support pillars with mushroom head reinforcements. The panels and mushroom head reinforcements are shown transparent. The structures, which are not normally visible from above from this viewpoint, are indicated as interrupted elements or lines. The panels 30 are joined together, preferably glued.

FIG. 6C is a schematic view from below of the same embodiment, with the arrangement of the mushroom head reinforcements on the panels marked.

FIGS. 7A and 7B illustrate a multi-storey mushroom floor ceiling girder system according to the present invention. The pillars 10 of the floor ceiling panels are arranged in a pillar grid. In a typical building, the spacing between the individual pillars is preferably 9 m about 6 m to 10 m, or 7 m to 9 m. Smaller distances are possible, but support pillars that are set too close together are unfavorable for the use of the space.

Support pillars 10 of a multi-storey structure are preferably arranged axially to the support pillars above and/or below. This is illustrated in FIGS. 7A and 7B.

The support pillars and mushroom head reinforcements in the illustrated embodiments are attached to a central area of the panels. However, it is also possible for the support pillars and mushroom head reinforcements to be arranged at interfaces of the panels.

A wood-based floor ceiling is usually assembled on site from several timber panels, as an entire floor ceiling cannot be delivered using conventional means of transportation due to its dimensions. The floor ceiling support system is also assembled on site.

According to the invention, a point-supported floor ceiling support system is assembled as follows:

One or preferably more support pillars 10 with an upper tapered portion 12 and a shoulder 115 surrounding the tapered portion are erected. The support pillars are preferably set up in a defined grid. When dimensioning the grid, the dimensions and arrangement of the panels and the alignment of prefabricated filling and venting openings in the panels should be taken into account.

The mushroom head reinforcements described above are then attached to the tapered portion 12 by means of their opening 3, so that the mushroom head reinforcement comes to rest on the shoulder 115 of the support pillar. It is also possible to attach the mushroom head reinforcements before the support pillars are erected.

In the next step, timber panels are placed on the support pillars with the mushroom head reinforcements. The timber panels may already be connected, preferably glued, to form at least part of a timber floor ceiling. However, it is also possible to place the panels individually on the mushroom head reinforcement(s). In this case, the panels can be bonded to the mushroom reinforcements and the to each another using a casting process.

The floor ceiling panels are aligned in such a way that at least one transverse fill opening 31 and at least one transverse vent opening 32 each open into the same cavity 4 or into the same segment Sn of a cavity of the mushroom head reinforcement. Preferably, the floor ceiling, or part of the panels, already has appropriately arranged fill openings 31 and vent openings 32 before being placed on the support pillars. These openings may be drill holes, for example.

It is also possible for the fill opening 31 and vent openings 32 to be made later in the panels that have already been laid, for example by drilling specific holes. However, this design is less favorable, as small pieces of wood that fall through the drilled holes can fall into the cavity and impair the quality of the adhesive layer formed therein, as well as the optimal spreading of the casting resin.

Once the timber floor ceiling panels have been placed on the support pillars with mushroom head reinforcements, the cavities 4 or their segments Sn may be filled with adhesive through fill openings 31. Ideally, the cavities or segments should be completely filled with adhesive. Air bubbles should be avoided, as this reduces the quality of the rigid joint to be formed.

In a subsequent step, the adhesive hardens without the application of pressure. In the assembled system, the boundaries of the cavity create a minimum depth that keeps the interior of the cavity essentially pressure-free. The weight of the panels rests on the boundaries so that the adhesive can cure in the cavity or in the segments without pressure.

To ensure that a cavity or segment is completely filled with adhesive, the following process steps may be optionally applied.

First, the adhesive is filled into the cavity or segment via the fill opening 31 until the filled adhesive emerges through the one or more vent openings 32. Each vent opening to which adhesive emerges is then preferably reversibly closed until adhesive emerges from each vent opening. The vent openings can, for example, be reversibly closed with a dowel.

The fill opening is not closed so that the filling level can be monitored. If the fill level drops, the vent hole plugs are removed and casting resin is added until adhesive escapes from all vent holes. The vent openings are then closed again.

If the filling level in the filling and venting opening remains constant, the joint is completely filled.

Once the cavity or segment has been completely filled, which is indicated by a constant filling level, the reversible sealing elements, such as dowels, can be removed from the vent openings. However, the sealing elements, for example dowels, may also be inserted deeper into the vent openings so that they do not protrude from the vent openings and permanently seal the cavity or segment.

The quality of a grouted cavity or segment may be determined as described below.

A cavity volume of a cavity covered by the timber construction panel, or a segment of a timber cavity, is calculated theoretically.

The adhesive volume of the adhesive filled into the cavity or segment is determined.

The calculated cavity volume is compared with the determined adhesive volume.

A statement about the quality of the bond is created. This statement is based on the fact that a deviation of the calculated cavity volume from the measured adhesive volume above a specified value can indicate a reduced quality of the bond.

If the calculated cavity volume is greater than the specified adhesive volume, this may indicate possible air pockets.

If the calculated cavity volume is smaller than the specified adhesive volume, this may indicate possible leaks.

1. A mushroom head reinforcement made of wood-based material for supporting and/or carrying timber building panels in building structures, comprising a base body with an upper surface, a lower surface facing away from the upper surface, and an opening extending from the upper surface to the lower surface,
wherein the mushroom head reinforcement has a cavity, or several cavities, extending at least over a part of the upper surface area,
wherein each cavity is at least partially limited by a closed boundary forming a barrier between the cavity and the opening, and
wherein each cavity is arranged to be completely filled with an adhesive to form an adhesive layer.

2. The mushroom head reinforcement according to claim 1, wherein the base body is a biaxially load-bearing timber component.

3. The mushroom head reinforcement according to claim 1, wherein the cavity or cavities is/are formed as a recess of the upper surface, and wherein the closed boundary is formed by a lateral wall of the respective recess.

4. The mushroom head reinforcement according to claim 1, wherein the cavity or cavities is/are each limited by a closed boundary arranged on the upper surface of the base body.

5. The mushroom head reinforcement according to claim 1, comprising a single cavity arranged around the opening and having an inner closed boundary forming a barrier to the opening and an outer closed boundary.

6. The mushroom head reinforcement according to claim 1, comprising a plurality of cavities, wherein the closed boundary of each cavity forms a barrier to the opening as well as a barrier to the other cavities.

7. The mushroom head reinforcement according to claim 1, wherein the upper surface and the lower surface are arranged substantially parallel to each other.

8. The mushroom head reinforcement according to claim 1, wherein the cavity or multiple cavities have a minimum depth of 1 mm, 2 mm, 3 mm, or 5 mm.

9. The mushroom head reinforcement according to claim 1, wherein the cavity or cavities comprises a plurality of segments (S1, S2, S3, Sn) which are separated from each other, each segment being arranged to receive an adhesive to form a planar adhesive layer.

10. A system comprising a biaxially load-bearing mushroom head reinforcement according to claim 1, a support pillar, and a biaxially load-bearing timber floor ceiling panel,
wherein the support pillar comprises a first portion having a first cross-sectional area (D1), and a second tapered portion having a second cross-sectional area (D2) which is smaller than the first cross-sectional area (D1), the second tapered portion being dimensioned to match and extend through the opening of the mushroom head reinforcement, and wherein the second tapered portion is surrounded by a shoulder formed by the first portion, wherein at least a portion of the lower surface of the mushroom head reinforcement rests on the shoulder when the mushroom head reinforcement and support pillar are assembled so that the shoulder supports the mushroom head reinforcement, and
wherein the timber floor ceiling panel comprises one or more transverse fill openings and one or more transverse vent openings, wherein fill openings and vent openings are aligned such that in the assembled system at least one fill opening and at least one vent opening open into the same cavity of the mushroom head reinforcement, or into the same segment of a cavity.

11. A system according to claim 10, wherein the support pillar is made of a wood-based material or of solid wood.

12. A method of making a point-supported floor ceiling system, comprising the steps of:
Erection of one or more support pillars comprising an upper tapered portion and a shoulder surrounding the tapered portion,
mounting of a biaxially supporting mushroom head reinforcement made of wood-based material according to claim 1, wherein the mushroom head reinforcement has an opening and a cavity or several cavities formed on an upper surface for enclosing an adhesive layer so that the tapered portion of the support pillar extends through the opening and so that the mushroom head reinforcement rests on the shoulder,
placement of a timber floor ceiling panel on the mushroom head reinforcement, the timber floor ceiling panel having at least one transverse fill opening and at least one transverse venting opening, and wherein the at least one fill opening and the at least one vent opening of the timber floor ceiling panel are arranged such that they each open into a same cavity of the mushroom head reinforcement, or into the same segment of a cavity, when the timber floor ceiling panel of the mushroom head reinforcement is placed on top;
filling the cavity or cavities with adhesive through the at least one fill opening so that the cavity or cavities are completely filled with adhesive,
curing without the application of pressure of the adhesive in the cavity or in the cavities.

13. The method according to claim 12, wherein one or more cavities is/are each divided into a plurality of segments (S1, S2, S3, Sn) which are separated from one another.

14. The method according to claim 12, wherein each cavity or each segment of a cavity is filled through a single fill opening arranged in a central region of the cavity or segment, and wherein each cavity or each segment of a cavity is vented through a plurality of vent openings arranged in the peripheral regions of the cavity or segment.

15. The method according to claim 12, wherein the adhesive is a paste-like casting resin.

16. The mushroom head reinforcement according to claim 2, wherein the cavity or cavities is/are formed as a recess of the upper surface, and wherein the closed boundary is formed by a lateral wall of the respective recess.
